(19) United States
(12) Patent Application Publication
(10) Pub. No.: US 2023/0325265 A1
(43) Pub. Date: Oct. 12, 2023

(54) HARDWARE ACCELERATION IN A NETWORK INTERFACE DEVICE

(71) Applicants: Susanne M. Balle, Hudson, NH (US); Duane Galbi, Wayland, MA (US); Shihwei Roger Chien, Hsinchu County (TW); Nagabhushan Chitlur, Portland, OR (US); Andrzej Kuriata, Gdansk (PL)

(72) Inventors: Susanne M. Balle, Hudson, NH (US); Duane Galbi, Wayland, MA (US); Shihwei Roger Chien, Hsinchu County (TW); Nagabhushan Chitlur, Portland, OR (US); Andrzej Kuriata, Gdansk (PL)

(21) Appl. No.: 18/334,025

(22) Filed: Jun. 13, 2023

(51) Int. Cl. G06F 9/54; H04L 69/18

(52) U.S. Cl. CPC G06F 9/547; H04L 69/18

(57) ABSTRACT

A network interface device connects to one or more endpoint devices and a network. The network interface device receives packet from the network and parses the packet to determine characteristics of the packet, where the packet includes serialized data according to a serialization format. Based on the characteristics, the network interface device determines whether data within the packet can be deserialized using data transformation acceleration hardware provided on the network interface device and which of a plurality of sub-protocols of a multiprotocol interconnect are to be utilized to transport the data to a destination device in the one or more endpoint devices.

### FIELD

The present disclosure relates in general to the field of distributed computing systems, and more specifically, to data transfers within computing clusters.

### BACKGROUND

A datacenter may include one or more platforms, where the platforms include at least one processor and associated memory modules. Platforms in the datacenter may facilitate the performance of any suitable number of processes associated with various applications running on the platform. These processes may be performed by the processors and other associated logic of the platforms. Platforms may additionally include I/O controllers, such as network adapter devices, which may be used to send and receive data on a network for use by the various applications.

### BRIEF DESCRIPTION OF THE DRAWINGS

FIG. 1 illustrates a block diagram of components of a datacenter in accordance with certain embodiments.

FIG. 2 is a simplified block diagram of an example computing system including example computing clusters.

FIG. 3A illustrates a simplified block diagram of an example computing system utilizing a link compliant with a Compute Express Link (CXL)-based protocol.

FIG. 3B illustrates a simplified block diagram of example protocol circuitry.

FIGS. 4A-4C are simplified block diagrams illustrating example device types within a Compute Express Link (CXL) infrastructure.

FIG. 5 is a simplified block diagram illustrating memory pooling using a CXL protocol.

FIG. 6 is a simplified block diagram illustrating an example data center cluster architecture.

FIG. 7 is a simplified block diagram illustrating data transfers within an example data center cluster architecture.

FIGS. 8A-8B are simplified block diagrams illustrating example remote procedure call stacks.

FIG. 9 is a simplified block diagram illustrating an example network interface device.

FIG. 10 is a simplified block diagram illustrating example data transfer paths facilitated using an example network interface device.

FIG. 11 is a simplified block diagram illustrating example disaggregation of data and control traffic from an example packet.

FIG. 12 is a simplified flow diagram illustrating an example technique for applying hardware acceleration to communications involving a network interface device.

FIG. 13 illustrates a block diagram of an example processor device in accordance with certain embodiments.

Like reference numbers and designations in the various drawings indicate like elements.

### DETAILED DESCRIPTION

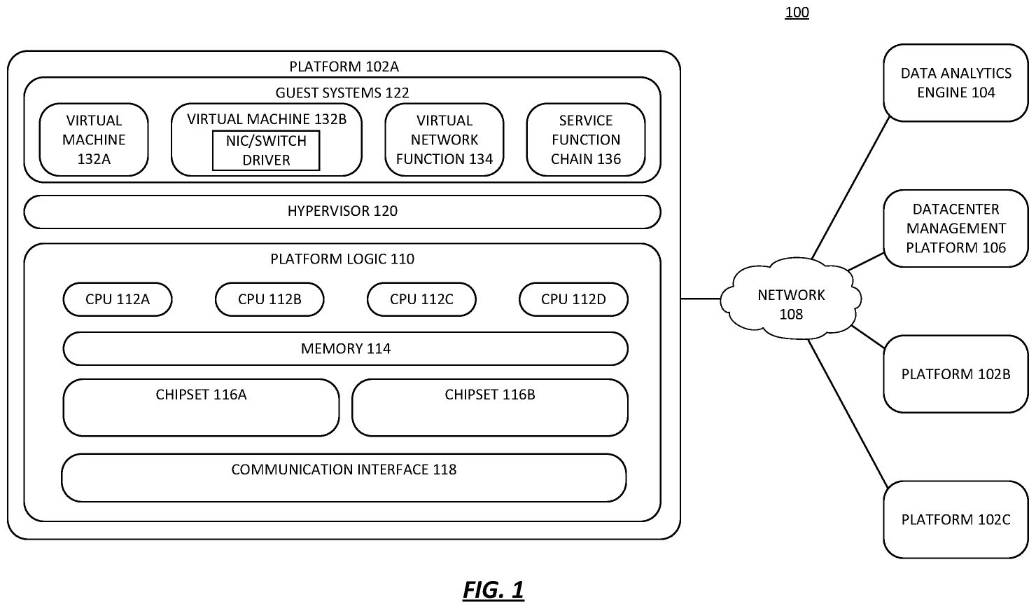

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators and the use of Compute Express Link (CXL) memory semantics to make such clusters more efficient, among other example enhancements.

Computing platforms 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may include any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. Although four CPUs are shown, a platform 102 may include any suitable number of CPUs.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may include memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. A chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on the CPUs.

Chipsets 116 may include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniB and, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. A platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniB and, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the datacenter 100 may be coupled together in any suitable, manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

In an improved system implementation, a data center cluster may be implemented utilizing the CXL-based communication channels. For instance, a CXL-based data center cluster may include a number of host computers coupled to a CXL-based switch. Traffic within the cluster and between clusters may be implemented utilizing a network processor device (e.g., a smart network interface controller (NIC), data processing unit (DPU), infrastructure processing unit (IPU), programmable networking device, etc.), which is connected to the CXL-based switch. Local memory of the network processor device may be utilized to construct a shared memory pool for the cluster, which can be leveraged to facilitate efficient data transfers utilizing CXL. CXL enables a more efficient data transmission than TCP and RDMA between the processors and accelerators of the cluster. The network processor device may be configured with logic (implemented in hardware, firmware, and/or software) to perform near-data processing for the cluster and reduce the memory movement, to thereby provide more efficient performance in an improved service mesh cluster architecture. Such an architecture can be used to implement data center clusters with reduced memory movement between hosts, lower latency, improved resource utilization, and lower power consumption, among other example benefits.

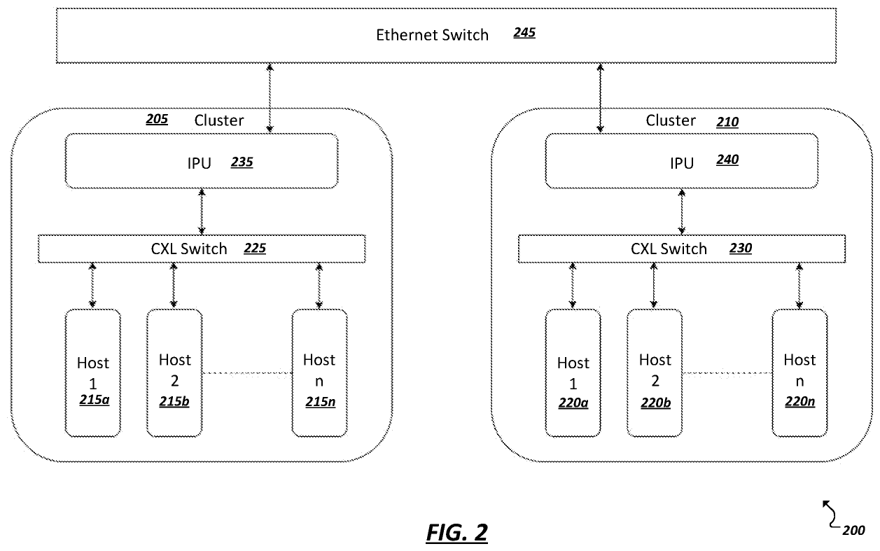

Networking processing devices, such as IPUs, smart NICs, or other network processing elements may be utilized within computing systems to enhance the performance of elements within a computing network, system or platform. For instance, FIG. 2 is a simplified block diagram 200 illustrating an example implementation of an improved data center cluster architecture. In this example, clusters 205, 210 are shown, the clusters implemented to include respective host computing devices (e.g., 215a-n, 220a-n) coupled to a switch 225, 230 in the cluster 205, 210. A cluster 205, 210 may further include a network interface device (e.g., an IPU or smart NIC) 235, 240 to manage the corresponding cluster (e.g., 205, 210). Further, the network interface devices (e.g., 235, 240) of the various clusters (e.g., 205, 210) may be interconnected with other network interface devices of other clusters, for instance, using an Ethernet or other interconnect. For instance, one or more switches (e.g., Ethernet switch 245) may be utilized to facilitate such an inter-cluster network.

As shown in the example of FIG. 2, a single service mesh cluster (e.g., 205) may be equipped with a switch 225 (e.g., a CXL switch) and network interface device 235, and the servers (e.g., hosts 215a-n) belonging to this cluster are connected to the CXL switch 225 and network interface device 235. The scalability of host servers may vary from cluster to cluster, with clusters capable of including various numbers of host server system based on the dimensions of the CXL switch (e.g., implemented as one rack of servers or multiple racks, etc.). A service mesh may be composed of one cluster or multiple interconnected clusters, such as illustrated in the example of FIG. 2. Cross-cluster connections are managed by the network interface device through the inter-cluster switch (e.g., 245). Additionally, the cluster's network interface device (e.g., 235, 240) may be additionally tasked with handling the ingress and egress traffic of the cluster and distribute the requests between the host servers (e.g., 215a-n) inside the cluster (e.g., 205). In some implementations, microservices may be hosted by various host server systems within an example service mesh, among other example applications.

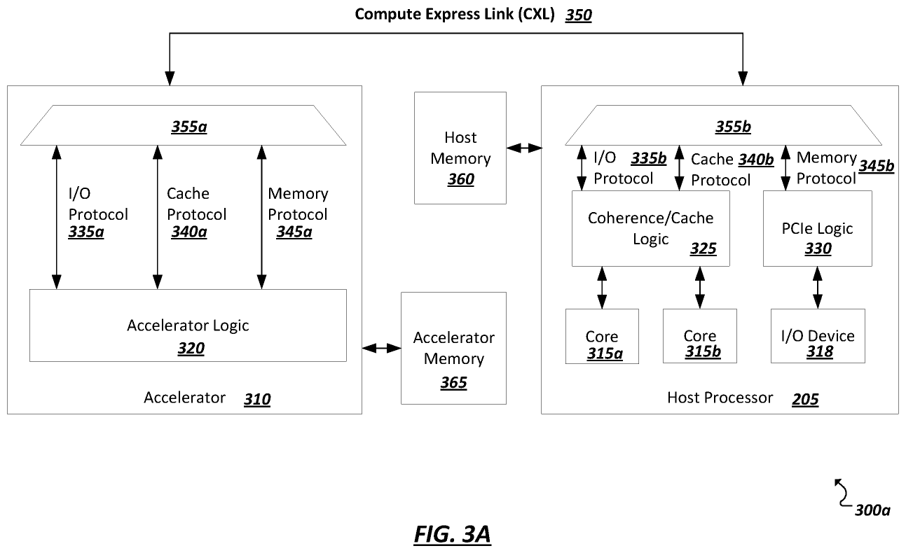

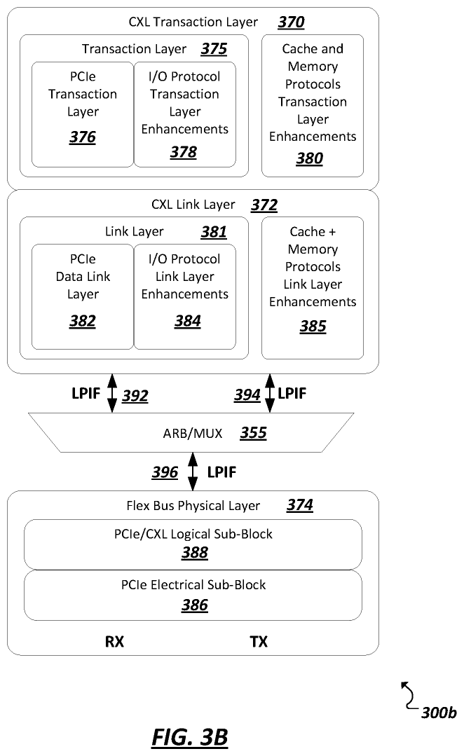

Various interconnect protocols may be utilized to interconnect network interface devices with other computing devices in a cluster. In some implementations, Compute Express Link (CXL)-based protocols may be utilized to enhance performance of communications within a network. FIGS. 3A-3B are simplified block diagrams illustrating example protocol logic, implemented in hardware and/or software, to implement a Compute Express Link (CXL) protocol (e.g., in one or more ports of a device within a system). It should be appreciated, that while much of the discussion centers on features provided by a CXL-protocol and communication channels compliant with CXL, that other substitute protocols with similar, comparable features may be substituted for CXL in the embodiments discussed below. The CXL interconnect protocol is designed to provide an improved, high-speed CPU-to-device and CPU-to-memory interconnect designed to accelerate next-generation data center performance, among other application. CXL maintains memory coherency between the CPU memory space and memory on attached devices, which allows resource sharing for higher performance, reduced software stack complexity, and lower overall system cost, among other example advantages. CXL enables communication between host processors (e.g., CPUs) and a set of workload accelerators (e.g., graphics processing units (GPUs), field programmable gate array (FPGA) devices, tensor and vector processor units, machine learning accelerators, networking accelerators, purpose-built accelerator solutions, among other examples). Indeed, CXL is designed to provide a standard interface for high-speed communications, as accelerators are increasingly used to complement CPUs in support of emerging computing applications such as artificial intelligence, machine learning and other applications.

A CXL link may be a low-latency, high-bandwidth discrete or on-package link that supports dynamic protocol multiplexing of coherency, memory access, and input/output (I/O) protocols. Among other applications, a CXL link may enable an accelerator to access system memory as a caching agent and/or host system memory, among other examples. CXL is a dynamic multi-protocol technology designed to support a vast spectrum of accelerators. CXL provides a rich set of sub-protocols that include I/O semantics similar to PCIe (CXL.io), caching protocol semantics (CXL.cache), and memory access semantics (CXL.mem) over a discrete or on-package link. Based on the particular accelerator usage model, all of the CXL protocols or only a subset of the protocols may be enabled. In some implementations, CXL may be built upon the well-established, widely adopted PCIe infrastructure (e.g., PCIe 5.0, PCIe 6.0, etc.), leveraging the PCIe physical and electrical interface to provide advanced protocol in areas include I/O, memory protocol (e.g., allowing a host processor to share memory with an accelerator device), and coherency interface.

Turning to FIG. 3A, a simplified block diagram 300a is shown illustrating an example system utilizing a CXL link 350. For instance, the link 350 may interconnect a host processor 305 (e.g., CPU) to an accelerator device 310. In this example, the host processor 305 includes one or more processor cores (e.g., 315a-b) and one or more I/O devices (e.g., 318). Host memory (e.g., 360) may be provided with the host processor (e.g., on the same package or die). The accelerator device 310 may include accelerator logic 320 and, in some implementations, may include its own memory (e.g., accelerator memory 365). In this example, the host processor 305 may include circuitry to implement coherence/cache logic 325 and interconnect logic (e.g., PCIe logic 330). CXL multiplexing logic (e.g., 355a-b) may also be provided to enable multiplexing of CXL protocols (e.g., I/O protocol 335a-b (e.g., CXL.io), caching protocol 340a-b (e.g., CXL.cache), and memory access protocol 345a-b (CXL.mem)), thereby enabling data of any one of the supported protocols (e.g., 335a-b, 340a-b, 345a-b) to be sent, in a multiplexed manner, over the link 350 between host processor 305 and accelerator device 310.

In some implementations, a Flex Bus™ port may be utilized in concert with CXL-compliant links to flexibly adapt a device to interconnect with a wide variety of other devices (e.g., other processor devices, accelerators, switches, memory devices (e.g., near memory, far memory, pooled memory, tiered memory, cache, etc.), among other examples). A Flex Bus port is a flexible high-speed port that is statically configured to support either a PCIe or CXL link (and potentially also links of other protocols and architectures). A Flex Bus port allows designs to choose between providing native PCIe protocol or CXL over a high-bandwidth, off-package link. Selection of the protocol applied at the port may happen during boot time via auto negotiation and be based on the device that is plugged into the slot. Flex Bus uses PCIe electricals, making it compatible with PCIe retimers, and adheres to standard PCIe form factors for an add-in card.

FIG. 3B is a simplified block diagram 300b illustrating an example protocol stack and associated logic (implemented in hardware and/or software) utilized to implement CXL links. For instance, the protocol logic may be organized as multiple layers to implement the multiple protocols supported by the port. For instance, a port may include transaction layer logic (e.g., 370), link layer logic (e.g., 372), and physical layer logic (e.g., 374) (e.g., implemented all or in-part in circuitry). For instance, a transaction (or protocol) layer (e.g., 370) may be subdivided into transaction layer logic 375 that implements a PCIe transaction layer 376 and CXL transaction layer enhancements 378 (for CXL.io) of a base PCIe transaction layer 376, and logic 380 to implement cache (e.g., CXL.cache) and memory (e.g., CXL.mem) protocols for a CXL link. Similarly, link layer logic 372 may be provided to implement a base PCIe data link layer 382 and a CXL link layer (for CXl.io) representing an enhanced version of the PCIe data link layer 384. A CXL link layer 372 may also include cache and memory link layer enhancement logic 385 (e.g., for CXL.cache and CXL.mem).

Continuing with the example of FIG. 3B, a CXL link layer logic 372 may interface with CXL arbitration/multiplexing (ARB/MUX) logic 355, which interleaves the traffic from the two logic streams (e.g., PCIe/CXL.io and CXL.cache/CXL.mem), among other example implementations. During link training, the transaction and link layers are configured to operate in either PCIe mode or CXL mode. In some instances, a host CPU may support implementation of either PCIe or CXL mode, while other devices, such as accelerators, may only support CXL mode, among other examples. In some implementations, the port (e.g., a Flex Bus port) may utilize a physical layer 374 based on a PCIe physical layer (e.g., PCIe electrical PHY 386). For instance, a Flex Bus physical layer may be implemented as a converged logical physical layer 388 that can operate in either PCIe mode or CXL mode based on results of alternate mode negotiation during the link training process. In some implementations, the physical layer may support multiple signaling rates (e.g., 8 GT/s, 16 GT/s, 32 GT/s, etc.) and multiple link widths (e.g., x16, x8, x4, x2, x1, etc.). In PCIe mode, links implemented by the port may be fully compliant with native PCIe features (e.g., as defined in the PCIe specification), while in CXL mode, the link supports the features defined for CXL. Accordingly, a Flex Bus port may provide a point-to-point interconnect that can transmit native PCIe protocol data or dynamic multi-protocol CXL data to provide I/O, coherency, and memory protocols, over PCIe electricals, among other examples.

The CXL I/O protocol, CXL.io, provides a non-coherent load/store interface for I/O devices. Transaction types, transaction packet formatting, credit-based flow control, virtual channel management, and transaction ordering rules in CXL.io may follow all or a portion of the PCIe definition. CXL cache coherency protocol, CXL.cache, defines the interactions between the device and host as a number of requests that have at least one associated response message and sometimes a data transfer. The interface consists of three channels in each direction: Request, Response, and Data.

The CXL memory protocol, CXL.mem, is a transactional interface between the processor and memory and uses the physical and link layers of CXL when communicating across dies. CXL.mem can be used for multiple different memory attach options including when a memory controller is located in the host CPU, when the memory controller is within an accelerator device, or when the memory controller is moved to a memory buffer chip, among other examples. CXL.mem may be applied to transaction involving different memory types (e.g., volatile, persistent, etc.) and configurations (e.g., flat, hierarchical, etc.), among other example features. In some implementations, a coherency engine of the host processor may interface with memory using CXL.mem requests and responses. In this configuration, the CPU coherency engine is regarded as the CXL.mem Controller and the Mem device is regarded as the CXL.mem Subordinate. The CXL.mem Controller is the agent which is responsible for sourcing CXL.mem requests (e.g., reads, writes, etc.) and a CXL.mem Subordinate is the agent which is responsible for responding to CXL.mem requests (e.g., data, completions, etc.). When the Subordinate is an accelerator, CXL.mem protocol assumes the presence of a device coherency engine (DCOH). This agent is assumed to be responsible for implementing coherency related functions such as snooping of device caches based on CXL.mem commands and update of metadata fields. In implementations, where metadata is supported by device-attached memory, it can be used by the host to implement a coarse snoop filter for CPU sockets, among other example uses.

In some implementations, an interface may be provided to couple circuitry or other logic (e.g., an intellectual property (IP) block or other hardware element) implementing a link layer (e.g., 372) to circuitry or other logic (e.g., an IP block or other hardware element) implementing at least a portion of a physical layer (e.g., 374) of a protocol. For instance, an interface based on a Logical PHY Interface (LPIF) specification to define a common interface between a link layer controller, module, or other logic and a module implementing a logical physical layer (“logical PHY” or “logPHY”) to facilitate interoperability, design and validation re-use between one or more link layers and a physical layer for an interface to a physical interconnect, such as in the example of FIG. 3B. Additionally, as in the example of FIG. 3B, an interface may be implemented with logic (e.g., 381, 385) to simultaneously implement and support multiple protocols. Further, in such implementations, an arbitration and multiplexer layer (e.g., 355) may be provided between the link layer (e.g., 372) and the physical layer (e.g., 374). In some implementations, each block (e.g., 355, 374, 381, 385) in the multiple protocol implementation may interface with the other block via an independent interface (e.g., 392, 394, 396). In cases where bifurcation is supported, each bifurcated port may likewise have its own independent interface, among other examples.

CXL is a dynamic multi-protocol technology designed to support accelerators and memory devices. CXL.io is for discovery and enumeration, error reporting, peer-to-peer (P2P) accesses to CXL memory and host physical address (HPA) lookup. CXL.cache and CXL.mem protocols may be implemented by various accelerator or memory device usage models. An important benefit of CXL is that it provides a low-latency, high-bandwidth path for an accelerator to access the system and for the system to access the memory attached to the CXL device. The CXL 2.0 specification enabled additional usage models, including managed hot-plug, security enhancements, persistent memory support, memory error reporting, and telemetry. The CXL 2.0 specification also enables single-level switching support for fan-out as well as the ability to pool devices across multiple virtual hierarchies, including multi-domain support of memory devices. The CXL 2.0 specification also enables these resources (memory or accelerators) to be off-lined from one domain and on-lined into another domain, thereby allowing the resources to be time-multiplexed across different virtual hierarchies, depending on their resource demand. Additionally, the CXL 3.0 specification doubled the bandwidth while enabling still further usage models beyond those introduced in CXL 2.0. For instance, the CXL 3.0 specification provides for PAM-4 signaling, leveraging the PCIe Base Specification PHY along with its CRC and FEC, to double the bandwidth, with provision for an optional flit arrangement for low latency. Multi-level switching is enabled with the CXL 3.0 specification, supporting up to 4K Ports, to enable CXL to evolve as a fabric extending, including non-tree topologies, to the Rack and Pod level. The CXL 3.0 specification enables devices to perform direct peer-to-peer accesses to host-managed device memory (HDM) using Unordered I/O (UIO) (in addition to memory-mapped I/O (MMIO)) to deliver performance at scale. Snoop Filter support can be implemented in Type 2 and Type 3 devices to enable direct peer-to-peer accesses using the back-invalidate channels introduced in CXL.mem. Shared memory support across multiple virtual hierarchies is provided for collaborative processing across multiple virtual hierarchies, among other example features.

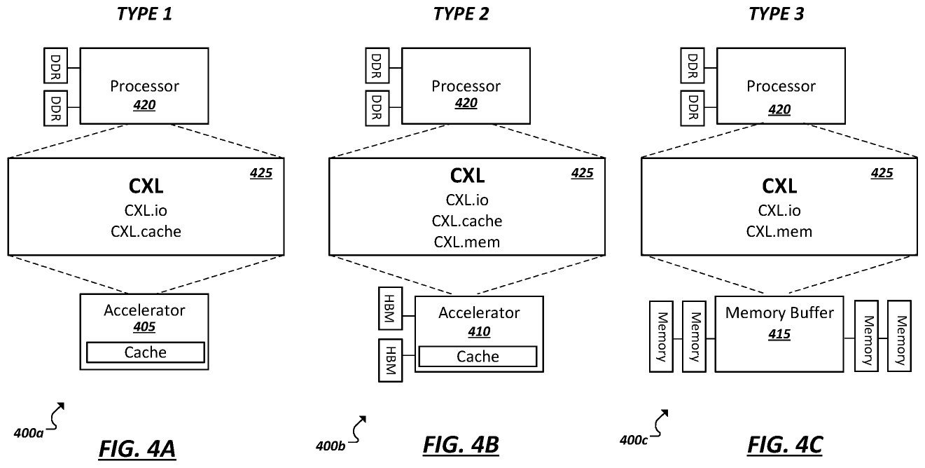

CXL may be used to interconnect peripheral devices that can be either traditional non-coherent I/O devices, memory devices, or accelerators with additional capabilities. When Type 2 and Type 3 device memory is exposed to the host, it is referred to as Host-managed Device Memory (HDM). The coherence management of this memory may be Host-only Coherent (HDM-H), Device Coherent (HDM-D), and Device Coherent using Back-Invalidation Snoop (HDM-DB). The host and device must have a common understanding of the type of HDM for each address region. FIGS. 4A-4C are simplified block diagrams 400a-c showing examples of CXL Type 1 devices (e.g., 405), Type 2 devices (e.g., 410), and Type 3 devices (e.g., 415). A CXL device (e.g., 405, 410, 415) may couple to a host processor (e.g., 420) via a CXL interconnect 425. Different CXL device types may utilize different combinations of the CXL protocols (or sub-protocols) (e.g., CXL.io, CXL.mem, CXL.cache).

In CXL, a “Type 1” devices have special needs for which having a fully coherent cache in the device becomes valuable. For such devices, standard producer-consumer ordering models do not work well. One example of a device with special requirements is to perform complex atomics that are not part of the standard suite of atomic operations present on PCIe. Basic cache coherency allows an accelerator to implement any ordering model it chooses and allows it to implement an unlimited number of atomic operations. These tend to require only a small capacity cache which can easily be tracked by standard processor snoop filter mechanisms. The size of cache that can be supported for such devices depends on the host's snoop filtering capacity. CXL supports such devices using its optional CXL.cache link over which an accelerator can use CXL.cache protocol for cache coherency transactions.

CXL “Type 2” devices, in addition to fully coherent cache, also have memory, for example DDR, High-Bandwidth Memory (HBM), or other memory attached to the device. These devices execute against memory, but their performance comes from having massive bandwidth between the accelerator and device-attached memory. One goal for CXL is to provide a means for the Host to push operands into device-attached memory and for the Host to pull results out of device-attached memory such that it does not add software and hardware cost that offsets the benefit of the accelerator. Systems may include coherent system address-mapped device-attached memory, also referred to as HDM with Device Managed Coherence (HDM-D/HDM-DB). There is an important distinction between HDM and traditional I/O and PCIe Private Device Memory (PDM). An example of such a device is a GPGPU with attached GDDR. Such devices have treated device-attached memory as private. This means that the memory is not accessible to the Host and is not coherent with the remainder of the system. It is managed entirely by the device hardware and driver and is used primarily as intermediate storage for the device with large data sets. A disadvantage to a model such as this is that it involves high-bandwidth copies back and forth from the Host memory to device-attached memory as operands are brought in and results are written back. Please note that CXL does not preclude devices with PDM.

At a high level, there are two example approaches of resolving device coherence of HDM. The first uses CXL.cache to manage coherence of the HDM and is referred to as “Device coherent.” The memory region supporting this flow is indicated with the suffix of “D” (HDM-D). The second approach uses the dedicated channel in CXL.mem called Back Invalidation Snoop and is indicated with the suffix “DB” (HDM-DB). With HDM-DB, the protocol enables new channels in the CXL.mem protocol that allow direct snooping by the device to the host using a dedicated Back-Invalidation Snoop (BISnp) channel. The response channel for these snoops is the Back-Invalidation Response (BIRsp) channel. The channels allow devices the flexibility to manage coherence by using an inclusive snoop filter tracking coherence for individual cache lines that may block new M2S Requests until BISnp messages are processed by the host.

A CXL “Type 3” device supports CXL.io and CXL.mem protocols. An example of a CXL Type 3 Device is a memory expander for the Host. Since this is not a traditional accelerator that operates on host memory, the device does not make any requests over CXL.cache. A passive memory expansion device would use the HDM-H memory region and while not directly manipulating its memory while the memory is exposed to the host. The device operates primarily over CXL.mem to service requests sent from the Host. The CXL.io protocol is used for device discovery, enumeration, error reporting and management. The CXL.io protocol is permitted to be used by the device for other I/O-specific application usages. The CXL architecture is independent of memory technology and allows for a range of memory organization possibilities depending on support implemented in the Host. Type 3 device Memory that is exposed as an HDM-DB enables the device to directly manage coherence with the host to enable in-memory computing and direct access using UIO on CXL.io. A Type 3 Multi-Logical Device (MLD) can partition its resources into up to multiple (e.g., 16) isolated Logical Devices. A Logical Device may be identified by a Logical Device Identifier (LD-ID) in CXL.io and CXL.mem protocols. A Logical Device visible to a Virtual Hierarchy (VH) may operate as a Type 3 device. The LD-ID is transparent to software. MLD components have common Transaction and Link Layers for each protocol across the LDs.

CXL is capable of maintaining memory coherency between the CPU memory space and memory on attached devices, so that any of the CPU cores or any of the other I/O devices configured to support CXL may utilize these attached memories and cache data locally on the same. Further, CXL allows resource sharing for higher performance, such that memory pooling may be achieved across different computing entities. Such CXL-enabled memory pools may enable enhanced and more efficient movement of operands. For instance, rather than utilizing DMA operation to transfer an entire segment of data from one computing element to the next computing element in association with a corresponding operation, coherent memory allows data to be moved seamlessly as if it were a simple transfer between the different cores in different CPU sockets. Such memory pooling can thus realize significant latency reduction and enable this aggregated memory in the system. Such features can enable more efficient memory usage, reduced architectural complexity, and thereby lower overall system costs. Further, such features allow programmers and system developers to focus on target workloads as opposed to redundant memory management, among other example benefits.

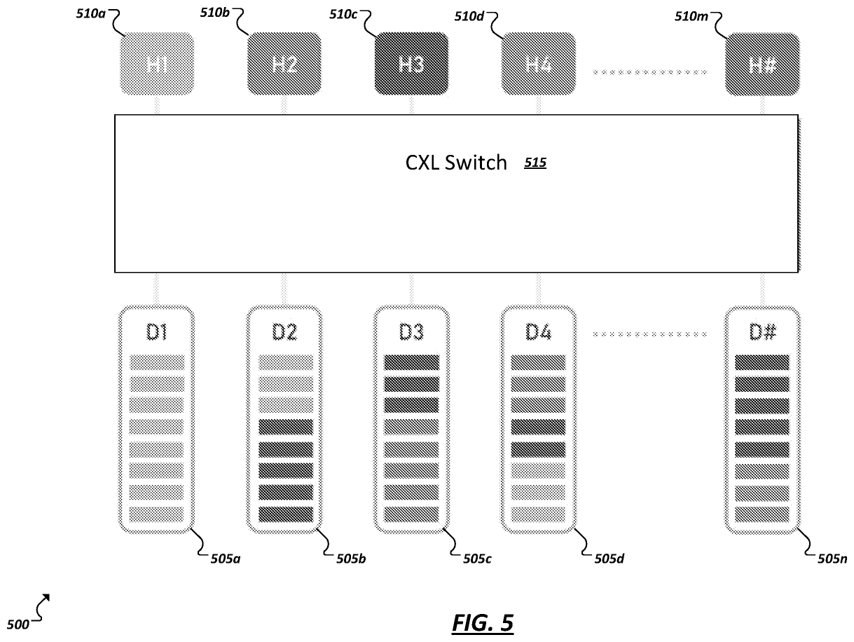

FIG. 5 is a simplified block diagram 500 illustrating the example pooling of multiple devices 505a-n (e.g., logical type 2 devices) to multiple host devices 510a-m. CXL (e.g., CXL 2.0) enables such pooling utilizing a CXL switch 515 (with a standardized CXL Fabric manager 518), where the memory on the devices 505a-n can be assigned to or shared with different hosts (e.g., 510a-m) and can be changed over time. The CXL switch 515 supports multiple hosts and is responsible for ensuring quality of service as well as isolation between different hosts. Other implementations, may utilize processing-in-memory (PIM) within their systems or cluster, including logic-in-memory or near-data processing. PIM technology aims to bring memory and computing closer instead of separating them, thus, improving the efficiency of data movement. Traditional PIM systems, however, may struggle with data coherence issues, as both a host processor and PIM processing can handle and compete for data, among other example issues.

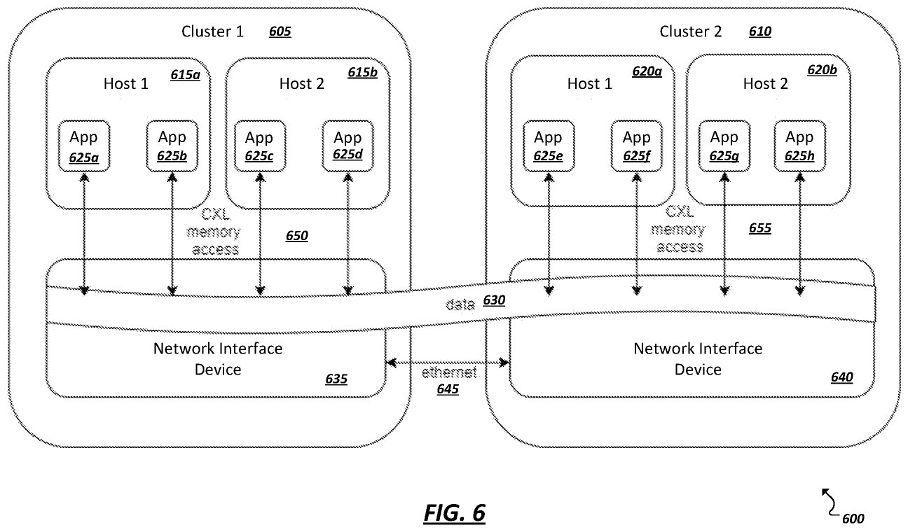

Improved node or cluster architectures may leverage the combined features of CXL and smart network interface devices (e.g., IPUs) to develop more efficient and better-performing service mesh clusters, which achieve these efficiencies with minimal movement of networking data and enhanced near memory processing. Such improved clusters can realize smaller latency, better resources utilization, and lower power consumption, among other example benefits. FIG. 6 is a simplified block diagram 600 illustrating a logical view of such a portion of such an improved cluster. As introduced above, a service mesh can be composed of one or multiple clusters (e.g., 605, 610). Host devices (e.g., 615a, 615b, 620a, 620b, etc.) may host various programs, services, microservices, or applications (e.g., 625a-h), which are executed on the corresponding host and which may share and operate various data on the service mesh. The data 630 moving within the cluster may be handled using the corresponding cluster's network interface device (e.g., 635, 640), with the network interface device further handling the inter-cluster communications and the internal connections of hosts and the network interface device within the cluster. Attached memory of the network interface device may be utilized to implement a memory pool for the cluster. Accordingly, data used in transactions within the cluster may be saved in the memory pool on the network interface device. Accordingly, when host device accesses the data within a transaction, the host device can utilize CXL memory accesses (e.g., 650, 655) to directly read or write data through the CXL cached memory as if it were local memory.

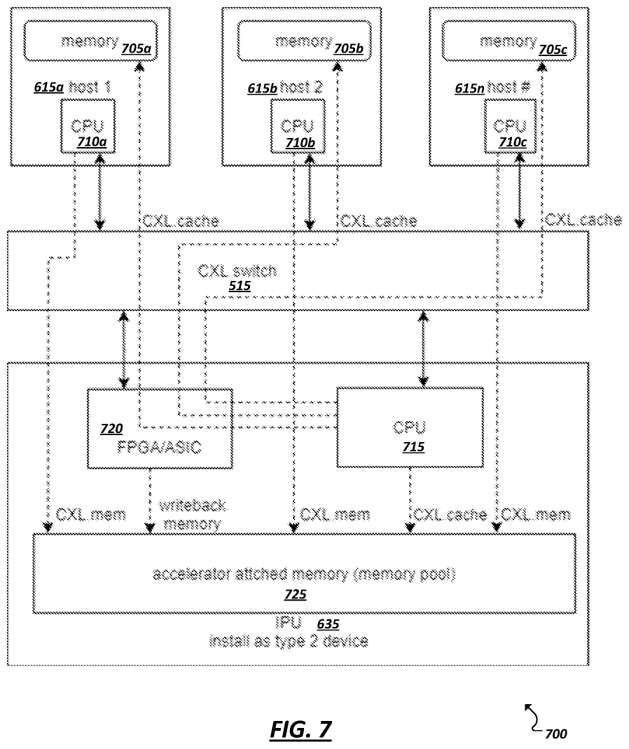

Turning to FIG. 7, a simplified block diagram 700 illustrating example hardware blocks of components within a cluster, such as the example shown in FIG. 6. For instance, a host device (e.g., 615a-n) may include respective local or attached memory (e.g., 705a-c) as well respective processing hardware 710a-c (e.g., CPU, FPGA, GPU, tensor processing unit (TPU), accelerator hardware, etc.), which may be utilized to host and execute various applications or portions of applications on the corresponding host. The host devices 615a-c may be connected to a CXL switch 515 for the cluster. The network interface device 635 of the cluster is also coupled to the switch 515. The network interface device 635 may include both a CPU 715 and programmable processing block 720 (e.g., a field programmable gate array (FPGA) or application-specific integrated circuit (ASIC)), together with attached memory 725, at least a portion of which is designated for use as a memory pool for the cluster.

In one example implementation, the network interface device 635 may be installed as a CXL type 2 device. Accordingly, the CPUs (e.g., 710a-c) of the hosts 615a-c, as well as the CPU (e.g., 715) of the network interface device 635, can cache (e.g., perform cacheable reads and cacheable writes of) the attached memory of the network interface device 635 using the CXL.mem subprotocol. The programmable processing block 720 of the network interface device 635 may cache the hosts' attached memory (e.g., 705a-c) using the CXL.cache subprotocol. Further, a dedicated hardware channel may be provided between the CPU 715 and programmable processing block 720 of the network interface device 635, allowing the CPU 715 to access the hosts' memories (e.g., 705a-c) through the programmable processing block 720 (e.g., also using the CXL.cache subprotocol), among other example features and implementations.

Data centers and data center networks continue to grow in prevalence and performance capabilities as cloud computing and other distributed computing architectures and systems grow in prevalence. With data center network speeds reaching 100 Gps and continuing to increase, conventional communication protocols may not be able to keep pace. For instance, the transmission control protocol (TCP) may struggle to provide the performance that cloud service providers need or desire to provide their respective services (e.g., infrastructure as a service (IaaS), software as a service (SaaS), platform as a service (PaaS), etc.). For instance, TCP may not be generally suited for latency sensitive processing due to its congestion management and retransmission control features, among other example issues. Further, data movement between memory, processors, and I/O devices struggle to meet the demands of memory intensive applications using traditional protocols.

Workloads handled by distributed computing architectures also continue to evolve. New workloads and applications challenge traditional data center assumptions and architectures. For instance, modern workloads may correspond to a set of microservices with various memory and bandwidth needs, with modern data centers struggling to accommodate dynamic changes in system configurations optimal for these various workloads and/or inefficiencies in reconfiguring system resources quickly between what can be short-lived microservice workloads. As additional examples, evolving machine learning and tensor processing workloads may require vastly different workloads from other more traditional applications. Data center designers traditionally face a choice: how to outfit a datacenter that is future proof and that can handle a wide range of applications or, alternatively, possesses specialized or custom capabilities optimized for select workload types.

Features of CXL and clusters and networks implemented using CXL offer a number of enhancements in how servers within a datacenter can communicate. Technologies like RDMA, that facilitate direct access of a remote node's memory, introduced the concept of availing direct access to a remote node's memory resources. Now, with CXL, this pushes the limits further by enabling modular system building to effectively plug-and-play various computing resources (e.g., caching devices/accelerators, accelerators with memory, and memory buffers) from a remote node to a given node. To accomplish such a system, however, considerations such as performance impacts, coherence requirements, quality of service, and other factors are to be considered and the system components configured accordingly. Modern system hardware lacks the logic to facilitate such system building.

In an improved system implementation, a data center cluster may be implemented utilizing CXL-based communication channels. For instance, a CXL-based data center cluster may include a number of endpoint computing devices (e.g., CPUs, graphic processors units (GPUs), tensor processing units (TPUs), hardware accelerators (e.g., accelerators for data compression, machine learning, deep learning, matrix processing, etc.), etc.) coupled within a cluster using a CXL-based switch. Traffic within the cluster and between clusters may be implemented and facilitated utilizing a network processor device (e.g., a smart NIC, data processing unit (DPU), IPU, programmable networking device, etc.), which is connected to or even incorporates the CXL-based switch for the cluster. Local memory of the network processor device may be utilized to construct a shared memory pool for the cluster, which can be leveraged to facilitate efficient data transfers utilizing CXL. CXL enables a more efficient data transmission than TCP and RDMA between the processors and accelerators of the cluster. The network processor device may be configured with logic (implemented in hardware, firmware, and/or software) to perform near-data processing for the cluster and reduce the memory movement, to thereby provide more efficient performance in an improved service mesh cluster architecture. Such an architecture can be used to implement data center clusters with reduced memory movement between hosts, lower latency, improved resource utilization, and lower power consumption, among other example benefits.

In modern computing environments, software services and applications are increasingly deployed in a distributed manner. For instance, an application or service may be deployed and executed across multiple computing systems, with each of the multiple computing systems implementing a component (e.g., a microservice) of the overall service. For instance, an application or service in a service oriented architecture may be implemented according to a microservice architecture. The component microservices may be implemented on machines of differing technologies and may be programmed using different computing languages or technologies. One of the challenges in a microservice architecture, as opposed to a monolithic software architecture, is implementing communication among the various components or microservice servers to implement the broader service or application. For instance, remote procedure calls (RPCs) may be utilized to facilitate intercommunication and interoperation between microservices. In some implementations, data transfers facilitated through RPCs or other communication mechanisms within a microservice architecture may include serialization and deserialization of the data as it passed from one microservice to another. Serialization is the processor of translating data (e.g., a data structure or object, which in some cases may be encapsulated within other data (e.g., a packet)) into a format that is more amenable to storage, transmission, or reconstructions, with deserialization being used to convert or transform serialized data back to its original format.

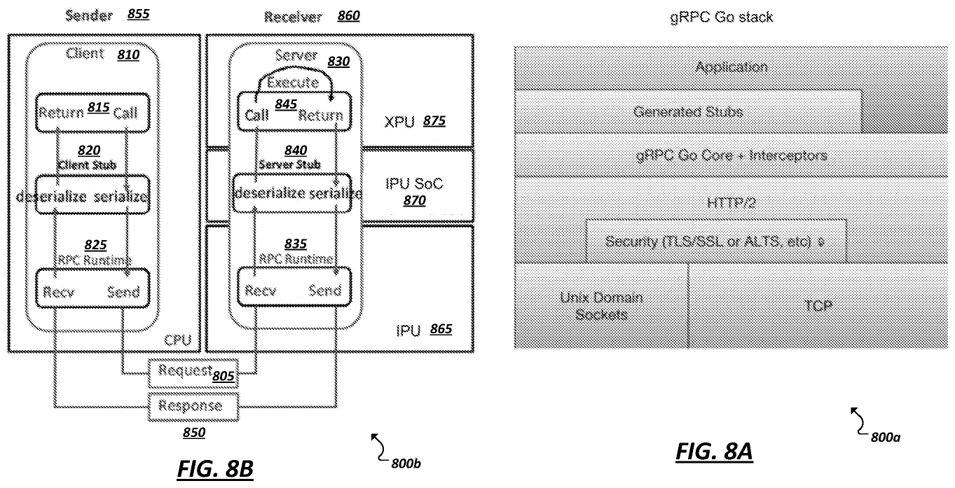

Turning to FIG. 8A, a simplified block diagram 800a is shown illustrating an example RPC stack, such as a Google RPC (gRPC) GO stack. An RPC stack may utilize data according to a particular serialization format to implement the interface description language for communication between microservices. For instance, in the case of gRPC, a protocol buffer (or “protobuf”) serialization format may be utilized. Some serialization formats may implement a cross-platform data format to enable data transfers between microservices of potentially multiple different code base languages and technologies.

As further illustrated by the simplified block diagram 800b of FIG. 8B, in an RPC communication, a “pitcher-catcher” architecture may be implemented between two systems 801, 802 implementing respective instances of an RPC (e.g., gRPC) stack. In the pitcher-catcher paradigm, a request 805 is called at an application layer 815 of the client 810 and passed to a client stub 820 for serialization before being sent on an interconnect to a receiver or server by an RPC runtime block 825. Likewise, a server 830 may receive the request 805 at its own RPC runtime block 835. A server stub 840 may perform serialization/deserialization at the server 830 and deserialize the serialized request 805 before passing up the stack to its execution or application layer 845. The server 830 may generate a response 850 to the request (e.g., in the application layer 845) and the response 850 may be serialized (at the server stub 840) passed to the RPC runtime 835 on the interconnect to the client 810, which may deserialize the response 850 (at client stub 820) before passing the response for consumption by the client's application layer 815. A computing platform (e.g., 855, 860) may function exclusively as a client or as a server or may function as either a client or a server depending on the transaction.

In some implementations, a gRPC or other RPC stack may be implemented using one or more multiple processing devices. For instance, a full RPC stack may be implemented on a single processing device, such as a CPU 855. In other instances, the RPC stack may be implemented on multiple different processing devices on a computing system or platform. For instance, computing platform 860 may include an IPU 865, which, itself, may include multiple processing elements, such as a CPU, host processor, or other general purpose processor on the IPU's SoC 870, and one or more network processors, programmable processors (e.g., FPGA, etc.), an ASIC, a networking accelerator, etc. In the example of FIG. 8B, the RPC runtime 835 may be implemented using the IPU 865 (e.g., network interface hardware of the IPU), the RPC stub or server stub 840 may be implemented on the IPU SoC 870, and the application layer(s) may be implemented using one more processing devices (e.g., XPUs) 875 communicatively coupled to the IPU (e.g., via a switch, a PCIe or CXL link, etc.).

The example of FIG. 8B may depict an example of microservices deployment on an IPU based on mapping of a gRPC stack. For example, gRPC communication can be sent using Transmission Control Protocol (TCP) or Unix domain sockets (e.g., User Datagram Protocol (UDP)). IPU 865 can include a system on chip (SoC) 870 that can execute a cloud native gRPC Go stack as a target for microservices. gRPC communications may include separate control and data traffic (e.g., implemented protobuf data).

When the RPC stack is divided amongst multiple processing devices and potentially multiple address spaces, the RPC stack performance may be compromised by communication bottlenecks (e.g., between system elements), inefficient memory accesses, among other example issues that result, for instance, from having various hardware (e.g., with more appropriate processing or software functionality and capabilities) handle or implement different layers or portions of the overall RPC stack, as in the example of platform 860. For instance, in an example gRPC stack, IPU 865 can include at least two interfaces to IPU SoC 870 and XPU 875. IPU SoC 865 can copy data to XPU 875 for processing. Latency can arise from IPU SoC 870 copying data to XPU 875. Additionally, serialization and deserialization of protobuf or other serialized data formats may involve similar coordination and data copying in order to perform, what in some instances, may be complex deserialization and serialization. For instance, conventional IPUs may be connected to other platform components (e.g., the CPU, other accelerators and XPUs) over PCIe-based links. Accesses into the in-memory protobuf representation, as performed during protobuf serialization and deserialization, may be ill-suited to being performed over PCIe (e.g., due to its relatively high latency), among other example issues. While examples are described with respect to gRPC, it should be appreciated that the solutions and principles discussed herein may also apply to other protocols such as JSON, XML, Open Network Compute (ONC) RPC, and others.

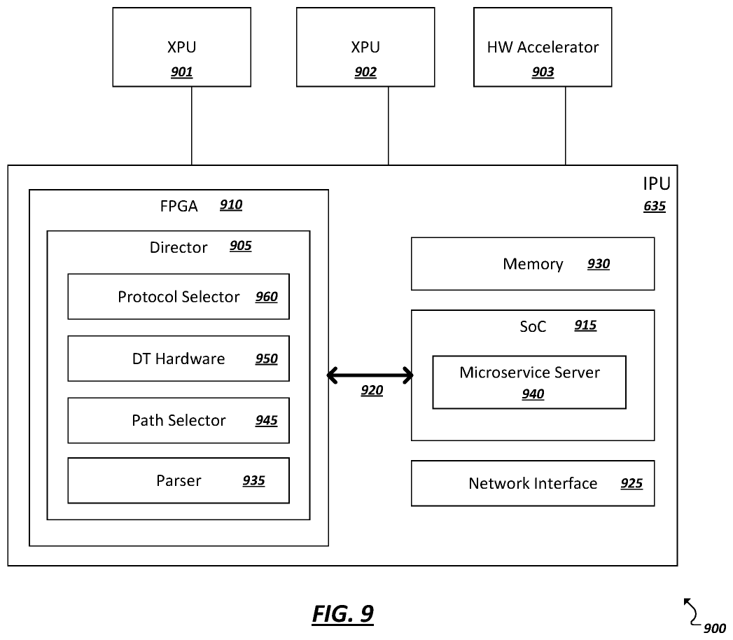

The tradeoff in leveraging the capabilities of in distributed platforms, are the datacenter-specific overheads, or “datacenter tax”, from relying on such architectures. Such overheads may largely arise from a distributed platform's reliance on inter-service communication between components (e.g., microservices and their host systems) in a distributed environment, for instance, through remote procedure calls. As the remote callee or server cannot directly access the caller's, or client's, memory space to read arguments and supply a response, data exchanged between the components may first be converted into a shared interchange format, via serialization and deserialization. Such exchanges may even involve exchanges between microservices written in different programming languages, which in some instances, may make serialization and deserialization even more demanding. FIG. 9 is a simplified block diagram 900 illustrating an example implementation of a computing platform on which microservices may be deployed, which includes the use of an enhanced network processor device 635 (e.g., an IPU). The network processor device 635 may be utilized to handle microservice-to-microservice communications. A microservice software stack such as a service mesh and operating system (OS) networking stack (e.g., Linux TCP/IP stack) can be offloaded from a general purpose processor for execution by a network interface device. The network interface device can receive data from a network intended for a microservice hosted or implemented by one or more accelerators or processors (XPUs) 901, 902, 903 coupled to the network interface device by one or more links (e.g., CXL links). The data can include control and data traffic. For example, the network interface device, such as a DPU or IPU, can provide control and data traffic to a general purpose processor (e.g., CPU) or processors in a system on chip (SoC) that executes a microservice server. In some cases, the microservice server may be hosted on the network interface device itself. However, in some cases, control and data traffic may be directed to and processed by different processing devices in a cluster managed by the network interface device. Latency of data processing can arise if the control and data are to be processed by different processors, among other issues. Where the data traffic is to be processed by an accelerator or other processor (e.g., XPU), the general purpose processor can provide data traffic to the accelerator (e.g., field programmable gate array (FPGA) executing one or more kernels) or other processors.

A variety of different XPUs and hardware elements may be coupled to a network interface device within a cluster. The XPUs can be used to implement various microservices and can even be shared across multiple microservices. Configuration of various XPUs and accelerators (e.g., FPGAs) can be based on load, workload type, and multiplexing microservices servers. Configuration of FPGA and director can be performed by an application or other software based on Storage Performance Development Kit (SPDK), Data Plane Development Kit (DPDK), OpenDataPlane (ODP), Infrastructure Programmer Development Kit (IPDK), among other examples.

An enhanced network interface device can include circuitry (e.g., system on chip (SoC)) or FPGA) that can enhance the manner in which control and/or data traffic is serialized and deserialized and/or directed to various devices (e.g., XPUs or accelerators) in a computing cluster whose communications are managed using the network interface device, in order to at least reduce latency or time to complete processing of data, among other example benefits. For instance, as shown in the example of FIG. 9, director hardware 905 may be provided in an example network interface device 635. In some implementations, the director hardware 905 may be implemented in a controller 910 (e.g., an FPGA or other processor element) of the network interface device 635. An SoC, CPU, or another processor device 915 provided on the network interface device 635 may be provided and interconnected with the controller 910 via an interconnect 920. The network interface device 635 may further include a network interface 925 through which a compute cluster (e.g., including the network interface device 635 and connected devices 901-903) may be coupled to a wider network (e.g., via one or more Ethernet connections). Data from other compute clusters (e.g., in a data cluster) may be received at the network interface device 635 and data from the local compute cluster may be sent to other compute clusters from the network interface device 635 using the network interface 925. The network interface device 635 may additionally include local memory 930 for use by processor devices 910, 915 in association with the operations performed at the network interface device 635.

Director hardware 905 of an example network interface device 635 may include a parser block 935 (e.g., implemented at least partially in hardware logic) to parse incoming data received at the network interface 925. For instance, serialized data (e.g., protobuf messages) may be received, among other types of data. The parser block 935 may detect the type or form of the received data and detect aspects of the data, including differentiating between control traffic and data traffic within the data. In some implementations, director hardware 935 may cause control traffic and data traffic to be disaggregated (e.g., from the same protobuf message) and direct control traffic to a microservice server 940 and data traffic to an accelerator or other processor (e.g., 901) for processing. A microservice server can include a processor-executed OS networking stack (e.g., Internet Control Message Protocol (ICMP) traffic, microservice discovery and configuration request). For example, the OS networking stack may not provide a determination if traffic is data traffic and is to be provided to an accelerator to avoid a data copy operation and avoid context switch. Accordingly, CSPs can deploy workloads in disaggregated datacenters and potentially utilize less power while delivering better performance per watt, while attempting to meet or exceed key performance indicators (KPIs) around performance per watt, algorithm design, etc.

Disaggregated control traffic from data traffic may allow for more efficient use of interconnect and SoC 915 and reduce data latency of XPUs who are to consume data traffic received at the network interface device 635, among other example benefits. For instance, in one example, instead of transferring network traffic from sender to the microservice server 940 executing on SoC 915, the director hardware 905 can separate configuration and data path at a network packet level. For instance, the director hardware 905 can process gRPC/HTTP2 messages and dispatch data (e.g., data primitives) to hardware accelerators 903 and/or XPUs 901, 902 (without transferring the data traffic over the SoC 915), while still forwarding the control and configuration traffic (e.g., control primitives) for microservice server 940 to perform gRPC control layers to maintain HTTP/2 (e.g., RFC 7540 (2015)) and TCP connections.

Director hardware 905 may also (or alternatively) utilize parser block 935 to detect attributes of serialized data received at the network interface. Given the potentially limitless variety of microservices that may deployed, similarly diverse data formats and definitions may be employed, with the serialization/deserialization of some data being relatively simple and the serialization/deserialization of other data being particular complex (e.g., based on the corresponding proto definition of corresponding protobuf data). For serialization formats, such as a protobuf, where the data is serialized to binary wire format and may involve translation of data from a sender microservice written in a first programming language and memory model and directed to a receiving microservice written in a different programming language or having a different memory model, serialization/deserialization may be a complex process. Indeed, in many cases, serialization/deserialization operations for some data may necessitate the use of specialized or custom software (e.g., where the serialization/deserialization is too “niche” to develop a hardware-based serialization/deserialization solution). Accordingly, the complexity of serialization/deserialization of data (e.g., protobuf, JSON, etc.) may vary widely in data received at the network interface device 635.

In some example implementations, director hardware 905 may include data translation hardware 950 that is configured or programmed to perform a limited defined subset of serialization/deserialization for particular serialization formats. For instance, a defined subset of the most common, “simple” use cases of protobuf data transformation may be identified and corresponding hardware (e.g., 950) configured to provide hardware acceleration of the serialization and deserialization of such data identified by the parser block 935 as corresponding to this subset. In this manner, hardware acceleration of serialization/deserialization of data received at the network interface 925 may be performed opportunistically directly at the network interface device 635. The deserialized data may then be passed from the network interface device 635 to the destination device (e.g., one of devices 901-903). For data outside of this subset, for which hardware-based serialization/deserialization is not available at the network interface device 635, the director hardware 905 may determine the destination (e.g., 901) of the data and pass the data, still in its serialized form, to the destination device to be deserialized (e.g., using software) at the destination device. Hardware acceleration of serialization/deserialization for at least some serialization formats, such as a protobuf, may be particular advantageous at the network interface device level. For instance, significant performance benefits and data latency savings may be enjoyed at scale within a data center utilizing such network interface devices and compute clusters. While many of the examples discussed herein have been within the context of data centers and clusters within a data center, it should be appreciated that the solutions, components, and features discussed herein may also be applied in other systems and architectures including edge nodes, content delivery networks (CDNs), micro-data centers, among other examples.

In some implementations, director hardware 905 may include a path selector block 945, which may work in concert with the parser block to direct data to the data translation hardware 950 for processing (e.g., serialization or deserialization) or not. In addition to being configured to perform a subset of deserialization at the network interface device, the data translation hardware 950 may also offer hardware acceleration of serialization, for instance, of responses or requests generated by connected devices (e.g., 901-903), allowing the corresponding workloads to be offloaded from the connected devices to the network interface device 635 for certain subsets of serialization operations.

In some implementations, a network interface device 635 may utilize a multi-protocol interconnect protocol to couple to one or more (or all) of the endpoint devices in a cluster. For instance, CXL may be utilized to couple the network interface device 635 to an endpoint device. Multiple different subprotocols may be defined and supported in a multi-protocol interconnect protocol. For instance, in the case of CXL (as noted above), sub-protocols may include a CXL.mem, CXL.cache, and CXL.io and ports of the network interface device 635 may support and multiplex between two or more of the sub-protocols when communicating over a CXL link with an endpoint device (e.g., 901-903). Accordingly, in some implementations, director hardware 905 may also include a protocol selector block 960 to enable a multi-transport option from/to the network interface device to/from the various endpoint devices (e.g., 901-903), wherein the sub-protocol (e.g., CXL.mem, CXL.cache, or CXL.io) is selected to transport the data based on the destination/source supported protocols as well as based on packet size and type and quality of service or other policy, among other examples.

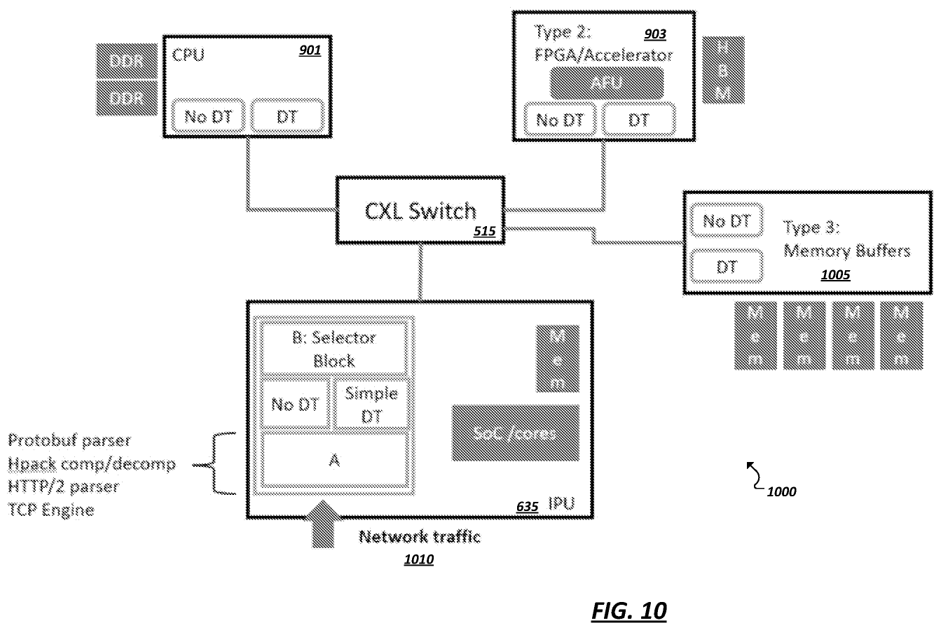

In FIG. 10, a simplified block diagram 1000 is shown illustrating an example implementation of a network interface device 635 (e.g., implemented as an IPU), equipped with serialization/deserialization hardware to accelerate a subset of serialization/deserialization for a subset of data handled by the IPU. The subset of serialization/deserialization accelerated at the IPU may be a subset of simple, straightforward, statistically common, or otherwise pre-defined serialization/deserialization operations. In this example, serialization/deserialization acceleration may operate on subsets of gRPC protobuf data. The director hardware may determine, for instance, for each packet received that includes protobuf data, whether deserialization of the protobuf object may be performed in hardware at the IPU and if not, may designate the data to be handled along a “no data transformation” or “No DT” path, as opposed to a “data transformation” or “DT” path, where the protobuf data is first deserialized at the IPU before being forwarded to its destination. In the case of the No DT path, the IPU may pass the data in its originally received, serialized form to the destination device (e.g., 901, 903, 1005). Further, whether the data is handled in the No DT or DT path, the IPU may additionally determine which CXL sub-protocol to use to transport the data to its destination, based on attributes of the data (e.g., the size of the data, whether the data was deserialized or not at the IPU, etc.), attributes of the destination device (e.g., the type of the device, the subprotocol supported by the device, memory attributes of the device, etc.), and/or attributes of a microservice (e.g., a quality of service or data integrity policy, data transport guarantee, or other policy) to which the data is associated, among other examples.

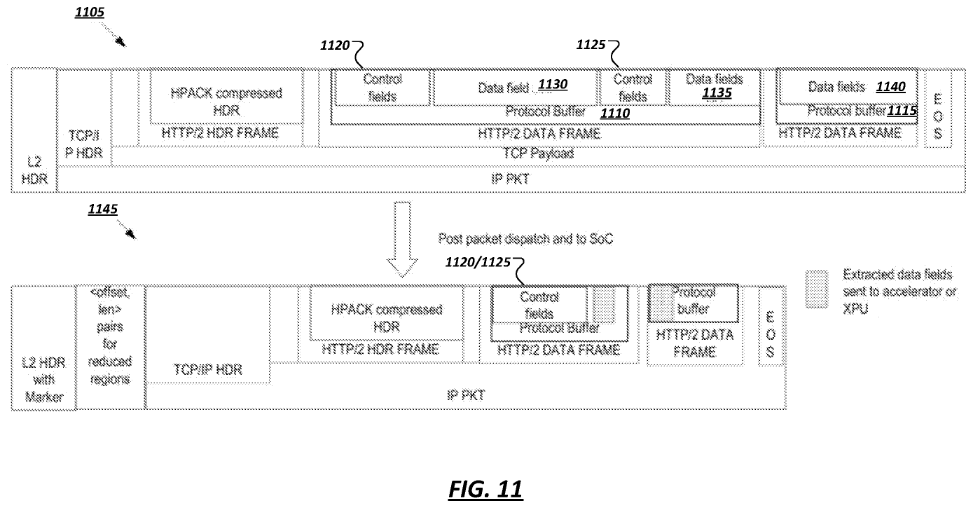

In some implementations, in addition to providing serialization/deserialization acceleration and multiprotocol selection at the IPU, autonomous disaggregation of control and data traffic may also be performed at the IPU. For instance, director hardware may separate control or configuration data present within a protobuf message from data traffic included in the protobuf message, thereby split the data and control paths. For instance, in the context of microservices architectures and gRPC, once TLS has been terminated, TCP and HTTP/2 packets may be reassembled and the hpack header decompressed, with the IPU splitting the protobuf bytestream into protobuf data and control fields. For instance, in the example of FIG. 11, an example packet 1105 is shown including one or more protobuf messages (e.g., 1110, 1115), which may include control (e.g., 1120, 1125) and/or data fields (e.g., 1130, 1135, 1140). The IPU may disaggregate the control and data fields by constructing a first packet (e.g., 1145) where the data fields are removed and only control fields (e.g., 1120/1125) remain, and forward this first packet for processing at the microservice server executed on the IPU. Likewise, a second packet (not shown in FIG. 11) may be similarly constructed to remove the control fields from the protobuf messages, and this second packet may be designated for forwarding on to the destination endpoint. The disaggregated (second) packet including the data fields, in some implementations, may then be parsed to determine whether hardware-based deserialization can be performed using the IPU's data transformation hardware acceleration capabilities (to place the second packet in the DT path) or not (and allocate the second packet for the No DT path).

Returning to the example of FIG. 10, a CXL switch 515 may be utilized within the cluster to couple various endpoint devices (e.g., 901, 903, 1005) to the network interface device 635 (e.g., IPU). Attached endpoint devices may be designated as CXL Type 1, 2, or 3 devices, and the sub-protocol selection may be based, at least in part, on the endpoint device designation. For instance, in the case of an IPU to Type 1 device (e.g., CPU) transfer over a CXL switch/link, the protocol selector block may lean toward or select a CXL.cache and CXL.io, or in the case of a policy that prioritizes transfers between CPU memory and IPU core memory, CXL.mem may be selected. In the case of an IPU-to-Type 2 accelerator device transfer over a CXL switch/link, the protocol selector block may select either CXL.io, CXL.cache, and CXL.cache, with the protocol selector block selecting CXL.mem for relatively smaller messages (e.g., messages with smaller payloads, such as a protobuf control fields or fields less than 256 B, etc.) and CXL.io for larger messages (e.g., messages with primarily protobuf data fields). In some cases, transfers Type 2 peer to peer communication may take place via CXL.io, although the IPU may also support CXL.io to CXL.cache or CXL.cache to CXL.mem between two Type 2 devices, or even CXL.mem for communication between Type 2 accelerator devices. In the case of IPU to Type3 memory buffer devices, the protocol selector block may choose CXL.io, CXL.cache, or CXL.mem based on the size/type of the payload, among other examples.

The IPU may determine the appropriate sub-protocol to use based on multiple factors. In some implementations, registers may be maintained to identify attributes of the various endpoint devices in the cluster, policies applicable within the cluster, and attributes of microservices implemented using the cluster. The protocol selector block may consult the register values to determine the sub-protocol to use. In some implementations, a machine learning or deep learning approach may be implemented by the protocol selector block to allow one or more machine learning or deep learning models to be trained to autonomously determine from a feature set developed from a set of attributes of the data, QoS, destination device, microservice, load balancing within the cluster, etc., which sub-protocol to select based on the feature set, among other example implementations.

In one example, the selector block may receive protobuf fields (e.g., deserialized by the simple data transformation IP block on the IPU and/or serialized protobuf fields) and determine the correct protocol to use between the IPU and the destination device for the protobuf fields to be transferred. The protocol selector block may be programmable by the control plane of the IPU (e.g., with per-flow configuration capability). In one example, configuration of the protocol selector block may be implemented in a manner similar to configuration of a networking data plane (e.g., via Program Protocol-independent Packet Processors (P4)). For instance, in one example, P4 may be used to program the protocol selector block with a P4 runtime interface available for control plane (e.g., management plane) to decide how source IP (src-IP), source port (src-port), protocol, destination IP (dst-IP), destination port (dst-port), and potential traffic class (e.g., encoded in VLAN/DSCP/MPLS headers) are used to select CXL destination. Further, the decision to delegate serialization/deserialization to another CXL device can be a result of congestion condition (e.g., queue occupancy above configurable threshold) on the IPU side, among other example features.

To facilitate a bi-direction support of DT and No DT serialization/deserialization paths within a cluster, endpoint devices (e.g., 901, 903, 1005) may also possess logic to identify when data to be sent over the IPU could be serialized using the IPU's data transformation hardware accelerator in the DT path or when serialization should be performed at the endpoint device before being forwarded (e.g., over a CXL link) to the IPU. Similarly, endpoint devices may possess logic to determine which sub-protocols to use in a communication with the IPU. In some instances, an endpoint device generates data as a response to a preceding request received in network traffic 1010 at the IPU and ultimately forwarded to the endpoint device. In some cases, the endpoint device may consider how the corresponding request packet was handled by the IPU (e.g., whether it was handled in the DT or No DT path, which subprotocol was used to transport the request to the endpoint device, etc.) and base its handling of the response packet on the request packet's handling by the IPU. In other instances, the logic of the endpoint devices may be more robust and self-determinative, with the endpoint device determining whether to send a packet in the DT or No DT path or using a particular CXL subprotocol, based on an analysis of the response packet's (or other packet's) characteristics (e.g., fields, serialization definition, size, etc.), and may even send responses in a DT/No DT path or CXL subprotocol that ends up different from how the corresponding request packet was handled by the IPU.

In some implementations, memory of the IPU cores (e.g., a CPU device (e.g., 901) may be mapped to the CPU's memory architecture allowing for optimized transfers between the IPU cores' memory and the CPU memory. In such instances, an available option for the CPU device would be to perform the “no DT” deserialization using the IPU cores (rather than the at the CPU or using the IPU's data transformation accelerator) and transfer the deserialized protobuf fields to the CPU device's memory directly, among other example features.

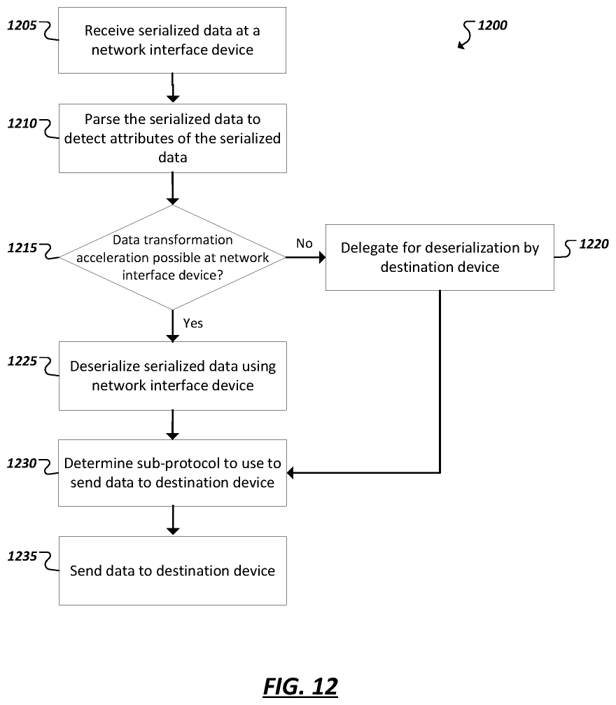

Turning to FIG. 12, a simplified flow diagram 1200 is shown illustrating an example technique for accelerating within a computing cluster using hardware of an enhanced network interface device. For instance, in the example of FIG. 12, data may be received 1205 from a network (e.g., originating from a device on another computing cluster implementing another microservice within a data center) at the network interface device. The received data may include serialized data such as protobuf data or according to another serialization format. The serialized data may be parsed 1210 at the network interface device to determine attributes of the data, including attributes of the serialization of the data. The network interface device may include data transformation acceleration hardware, which may include hardware-implemented logic to deserialize and/or serialize a subset of the data that is processed using the network interface device, when the data's attributes meet defined conditions. For instance, the data transformation acceleration hardware may be configured to perform relatively simple or statistically common subsets of deserialization and/or serialization operations, whereas other more complex or specialized deserialization/serialization operations may be left to software or specialized hardware executed on endpoint devices in the data cluster. The network interface device may opportunistically assist in deserialization/serialization when the results of the parsing of the data indicate that the serialized data is capable of being successfully deserialized using the data transformation acceleration hardware of the network interface device. The network interface device may determine (at 1215) whether data transformation (e.g., deserialization) may be performed using the network interface device's data transformation hardware. In cases where the network interface device determines that the nature of the received data's serialization is outside the capabilities of the network interface device's data transformation acceleration hardware, the network interface device may determine that the serialized data should be routed, as is, to its appropriate destination (e.g., an XPU, accelerator, memory device, or other device coupled to the network interface device (e.g., via a switch in a computing cluster)), thereby delegating 1220 the deserialization of the data to the destination device. Where deserialization is possible at the network interface device's data transformation acceleration hardware, the serialized data may be deserialized 1125 before passing the data on to its destination.

Links coupling a network interface device to various endpoint devices within a cluster may be according to multiprotocol interconnect protocols, such as CXL. The transport of data received on the network at the network interface device, whether serialized or deserialized, may be transported to the destination device within the cluster using one or more of the multiple sub-protocols of the multiprotocol interconnect protocol. For instance, prior to forwarding the data to the identified destination device (e.g., at 1235), the network interface device may determine, based on characteristics of the data (e.g., the amount of the data; the type of data; a QoS, security, or other policy applicable to the data; etc.) and/or the characteristics of the destination device (e.g., the type of device, a trust or security level or policy associated with the device, the sub-protocols supported by the device, etc.), which of the multiple sub-protocols to use when sending 1235 the data from the network interface device to the destination device (e.g., over a switch or a direct point-to-point link coupling the network interface device to the destination device), among other example features and implementations.

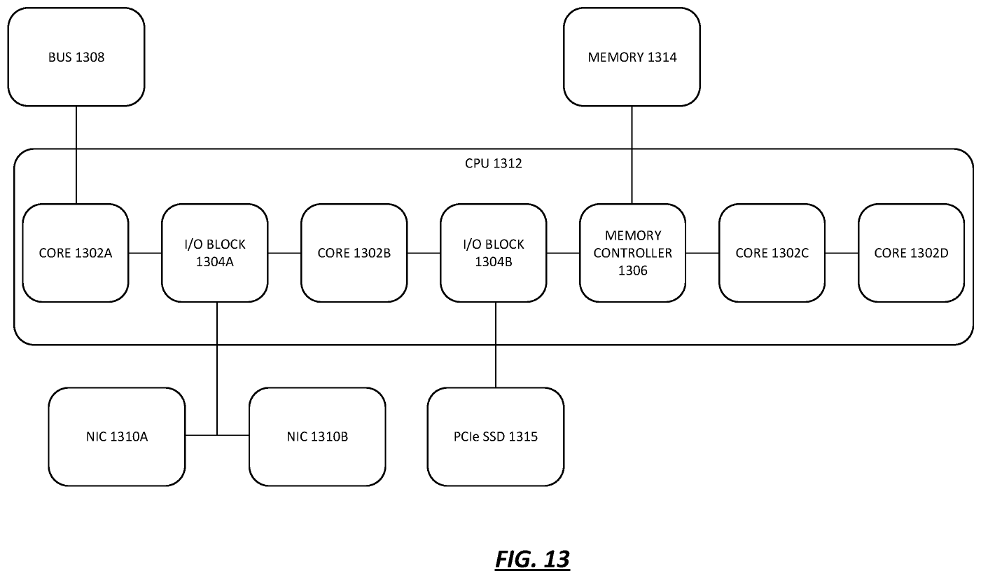

Note that the apparatus', methods', and systems described above may be implemented in any electronic device or system as aforementioned. As a specific illustration, FIG. 13 provides an exemplary implementation of a processing device such as one that may be included in a network interface device. It should be appreciated that other processor architectures may be provided to implement the functionality and processing of requests by an example network interface device, including the implementation of the example network interface device components and functionality discussed above. Further, while the examples discussed above focus on the use of CXL and CXL-based protocols, it should be appreciated that reference to CXL is as an illustrative example only. Indeed, the more generalized concepts disclosed herein may be equally and advantageously applied to other interconnects and interconnect protocols that facilitate similar features, among other examples.

Referring to FIG. 13, a block diagram is shown of an example data processor device (e.g., a central processing unit (CPU)) 1312 coupled to various other components of a platform in accordance with certain embodiments, such as those discussed above. Although CPU 1312 depicts a particular configuration, the cores and other components of CPU 1312 may be arranged in any suitable manner. CPU 1312 may comprise any processor or processing device, such as a microprocessor, an embedded processor, a digital signal processor (DSP), a network processor, an application processor, a co-processor, a system on a chip (SOC), or other device to execute code. CPU 1312, in the depicted embodiment, includes four processing elements (cores 1302 in the depicted embodiment), which may include asymmetric processing elements or symmetric processing elements. However, CPU 1312 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 1312, as illustrated in FIG. 13, includes four cores—cores 1302A, 1302B, 1302C, and 1302D, though a CPU may include any suitable number of cores. Here, cores 1302 may be considered symmetric cores. In another embodiment, cores may include one or more out-of-order processor cores or one or more in-order processor cores. However, cores 1302 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 1302 may include a decode module coupled to a fetch unit to decode fetched elements. Fetch logic, in one embodiment, includes individual sequencers associated with thread slots of cores 1302. Usually, a core 1302 is associated with a first ISA, which defines/specifies instructions executable on core 1302. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 1302 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 1302, in one embodiment, recognize the same ISA (or a subset thereof). Alternatively, in a heterogeneous core environment, a decoder of one or more cores (e.g., core 1302B) may recognize a second ISA (either a subset of the first ISA or a distinct ISA).

In various embodiments, cores 1302 may also include one or more arithmetic logic units (ALUs), floating point units (FPUs), caches, instruction pipelines, interrupt handling hardware, registers, or other suitable hardware to facilitate the operations of the cores 1302.

Bus 1308 may represent any suitable interconnect coupled to CPU 1312. In one example, bus 1308 may couple CPU 1312 to another CPU of platform logic (e.g., via UPI). I/O blocks 1304 represents interfacing logic to couple I/O devices 1310 and 1315 to cores of CPU 1312. In various embodiments, an I/O block 1304 may include an I/O controller that is integrated onto the same package as cores 1302 or may simply include interfacing logic to couple to an I/O controller that is located off-chip. As one example, I/O blocks 1304 may include PCIe interfacing logic. Similarly, memory controller 1306 represents interfacing logic to couple memory 1314 to cores of CPU 1312. In various embodiments, memory controller 1306 is integrated onto the same package as cores 1302. In alternative embodiments, a memory controller could be located off chip.

As various examples, in the embodiment depicted, core 1302A may have a relatively high bandwidth and lower latency to devices coupled to bus 1308 (e.g., other CPUs 1312) and to NICs 1310, but a relatively low bandwidth and higher latency to memory 1314 or core 1302D. Core 1302B may have relatively high bandwidths and low latency to both NICs 1310 and PCIe solid state drive (SSD) 1315 and moderate bandwidths and latencies to devices coupled to bus 1308 and core 1302D. Core 1302C would have relatively high bandwidths and low latencies to memory 1314 and core 1302D. Finally, core 1302D would have a relatively high bandwidth and low latency to core 1302C, but relatively low bandwidths and high latencies to NICs 1310, core 1302A, and devices coupled to bus 1308.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a network interface device including: a processor; a first port to couple to a network, where data is received from the network at the first port; a second port to couple to an endpoint device; data transformation hardware to perform deserialization of a subset of the data; parser hardware to: parse a packet in the received data to determine characteristics of the packet, where the packet includes serialized data according to a serialization format; and determine that the data transformation hardware is capable of deserializing the serialized data based on the characteristics, where the data transformation hardware deserializes the serialized data to generate deserialized data, and the network interface device sends the deserialized data to the endpoint device for consumption by the endpoint device.

Example 2 includes the subject matter of example 1, where the serialization format includes a protocol buffer (protobuf).

Example 3 includes the subject matter of example 2, where the data is received based on a Google Remote Procedure Call (gRPC) protocol.

Example 4 includes the subject matter of any one of examples 1-3, where second data is received from the network at the first port and the parser hardware is to: parse a second packet in the received second data to determine characteristics of the second packet, where the second packet includes other serialized data according to the serialization format; and determine that the data transformation hardware does not support deserialization of the other serialization data based on the characteristics, where the network interface device sends the other serialized data to the endpoint device to be deserialized at the endpoint device prior to consumption of the other serialized data by the endpoint device.

Example 5 includes the subject matter of example 4, where deserialization of the serialized data is computationally simpler than deserialization of the other serialized data.

Example 6 includes the subject matter of any one of examples 1-5, where the endpoint device implements at least a portion of a first microservice, the data is received from a second microservice implemented on another system on the network.

Example 7 includes the subject matter of example 6, where response data is received at the network interface device at the second port from the endpoint device based on the deserialized data, where the response data is serialized by the data transformation hardware to generate serialized response data, and the network interface device sends the serialized response data to the other system over the network.

Example 8 includes the subject matter of any one of examples 6-7, where the first microservice and the second microservice are written in different programming languages.

Example 9 includes the subject matter of any one of examples 1-8, where the network interface processor further includes protocol selector circuitry to select a particular one of a plurality of sub-protocols of an interconnect protocol to use to send the deserialized data to the endpoint device based on one or more of the characteristics of the packet or characteristics of the endpoint device.

Example 10 includes the subject matter of example 9, where the interconnect protocol includes a Compute Express Link (CXL)-based protocol, and the plurality of sub-protocols include CXL.io, CXL.mem, and CXL.cache.

Example 11 includes the subject matter of any one of examples 9-10, where the characteristics of the packet include a size of the packet or a quality of service associated with the packet, and the characteristics of the endpoint device include a type of the endpoint device or sub-protocols supported by the endpoint device.

Example 12 includes the subject matter of any one of examples 1-11, where the parser hardware is further to disaggregate data traffic fields from control fields in the packet, and the data traffic fields include the serialized data to be deserialized by the data transformation hardware.

Example 13 is a method including: receiving a packet from another computing system over a network at a network interface device, where the packet is destined for an endpoint computing device coupled to the network interface device; parsing the packet to detect serialized data within the packet; determining characteristics of the serialized data; determining whether deserialization hardware on the network interface device is capable of deserializing the serialized data based on the characteristics; deserializing the serialized data using the deserialization hardware to generate deserialized data based on determining that the deserialization hardware on the network interface device is capable of deserializing the serialized data; determining a particular one of a plurality of sub-protocols of a multiprotocol interconnect to use to send the deserialization data; and sending the deserialized data from the network interface device to the endpoint device over the multiprotocol interconnect using the particular sub-protocol.

Example 14 includes the subject matter of example 13, where the deserialization hardware is limited to deserializing serialized data meeting a particular set of conditions, and the network interface device is to send serialized data to the endpoint device for deserialization at the endpoint device when the deserialization hardware is incapable of deserializing the serialized data.

Example 15 includes the subject matter of any one of examples 13-14, where the multiprotocol interconnect is compliant with a CXL-based protocol, and the plurality of sub-protocols include CXL.io, CXL.mem, and CXL.cache.

Example 16 includes the subject matter of any one of examples 13-15, where the serialized data is serialized in accordance with a serialization format and the serialization format includes a protocol buffer (protobuf).

Example 17 includes the subject matter of example 16, where the data is received based on a Google Remote Procedure Call (gRPC) protocol.

Example 18 includes the subject matter of any one of examples 13-17, where second data is received from the network at the first port and the method further includes: parsing a second packet in the received second data to determine characteristics of the second packet, where the second packet includes other serialized data according to the serialization format; and determining that the data transformation hardware does not support deserialization of the other serialization data based on the characteristics, where the network interface device sends the other serialized data to the endpoint device to be deserialized at the endpoint device prior to consumption of the other serialized data by the endpoint device.

Example 19 includes the subject matter of example 18, where deserialization of the serialized data is computationally simpler than deserialization of the other serialized data.

Example 20 includes the subject matter of any one of examples 13-19, where the endpoint device implements at least a portion of a first microservice, the data is received from a second microservice implemented on another system on the network.

Example 21 includes the subject matter of example 20, where response data is received at the network interface device at the second port from the endpoint device based on the deserialized data, where the response data is serialized by the data transformation hardware to generate serialized response data, and the network interface device sends the serialized response data to the other system over the network.

Example 22 includes the subject matter of example 20, where the first microservice and the second microservice are written in different programming languages.

Example 23 includes the subject matter of any one of examples 13-22, where the particular one of a plurality of sub-protocols of a multiprotocol interconnect is selected based on one or more of characteristics of the packet or characteristics of the endpoint device.

Example 24 includes the subject matter of example 23, where the characteristics of the packet include a size of the packet or a quality of service associated with the packet, and the characteristics of the endpoint device include a type of the endpoint device or sub-protocols supported by the endpoint device.

Example 25 includes the subject matter of any one of examples 13-24, further including disaggregating data traffic fields from control fields in the packet, and the data traffic fields include the serialized data to be deserialized by the data transformation hardware.

Example 26 is a system including means to perform the method of any one of examples 13-25.

Example 27 is a system including: a first computing cluster including: a set of endpoint devices; and a network interface device including: a processor; a first port to couple to a network, where data is received from the network at the first port, where the data includes serialized data and is destined for a particular one of the set of endpoint devices; one or more second ports to couple to the set of endpoint devices; deserialization/serialization acceleration circuitry to perform deserialization of the serialized data; parser hardware to: parse the serialized data to determine characteristics of the serialized data; and determine that the deserialization/serialization acceleration circuitry is capable of deserializing the serialized data based on the characteristics, where the data transformation hardware deserializes the serialized data to generate deserialized data, and the network interface device sends the deserialized data to the particular endpoint device over a multiprotocol link.

Example 28 includes the subject matter of example 27, where the network interface device includes one of an infrastructure processing unit (IPU) or a smart network interface card (smart NIC).

Example 29 includes the subject matter of any one of examples 27-28, where the serialized data includes protobuf data.

Example 30 includes the subject matter of any one of examples 27-29, where the set of endpoint devices include one or more of a processor device, an accelerator device, or a memory buffer device.

Example 31 includes the subject matter of any one of examples 27-30, where each endpoint device in the set of endpoint devices includes deserialization/serialization logic to deserialization serialized data which cannot be deserialized using the deserialization/serialization acceleration circuitry of the network interface device.

Example 32 includes the subject matter of example 31, where the deserialization/serialization logic of one or more of the set of endpoint devices is implemented in software.

Example 33 includes the subject matter of any one of examples 27-32, further including a second cluster coupled to the first cluster by the network and the data is received from the second cluster.

Example 34 includes the subject matter of example 34, where the particular endpoint device is used to implement a first microservice and a second microservice is implemented on the second cluster.

Example 35 includes the subject matter of any one of examples 27-34, where the network interface processor further includes protocol selector circuitry to select a particular one of a plurality of sub-protocols of an interconnect protocol to use to send the deserialized data to the particular endpoint device based on one or more of the characteristics of the packet or characteristics of the particular endpoint device.

Example 36 includes the subject matter of example 35, where the interconnect protocol includes a Compute Express Link (CXL)-based protocol, and the plurality of sub-protocols include CXL.io, CXL.mem, and CXL.cache.

Example 37 includes the subject matter of any one of examples 27-36, where the data is received based on a Google Remote Procedure Call (gRPC) protocol.

Example 38 includes the subject matter of any one of examples 27-37, where second data is received from the network at the first port and the parser hardware is to: parse a second packet in the received second data to determine characteristics of the second packet, where the second packet includes other serialized data according to the serialization format; and determine that the data transformation hardware does not support deserialization of the other serialization data based on the characteristics, where the network interface device sends the other serialized data to the endpoint device to be deserialized at the endpoint device prior to consumption of the other serialized data by the endpoint device.

Example 39 includes the subject matter of example 38, where deserialization of the serialized data is computationally simpler than deserialization of the other serialized data.

Example 40 includes the subject matter of any one of examples 27-39, where the endpoint device implements at least a portion of a first microservice, the data is received from a second microservice implemented on another system on the network.

Example 41 includes the subject matter of example 40, where response data is received at the network interface device at the second port from the endpoint device based on the deserialized data, where the response data is serialized by the data transformation hardware to generate serialized response data, and the network interface device sends the serialized response data to the other system over the network.

Example 42 includes the subject matter of example 40, where the first microservice and the second microservice are written in different programming languages.

Example 43 includes the subject matter of any one of examples 27-43, where the network interface processor further includes protocol selector circuitry to select a particular one of a plurality of sub-protocols of an interconnect protocol to use to send the deserialized data to the endpoint device based on one or more of the characteristics of the packet or characteristics of the endpoint device.

Example 44 includes the subject matter of example 43, where the characteristics of the packet include a size of the packet or a quality of service associated with the packet, and the characteristics of the endpoint device include a type of the endpoint device or sub-protocols supported by the endpoint device.

Example 45 includes the subject matter of any one of examples 27-44, where the parser hardware is further to disaggregate data traffic fields from control fields in the packet, and the data traffic fields include the serialized data to be deserialized by the data transformation hardware.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a network interface device comprising:
a processor;
a first port to couple to a network;
a second port to couple to an endpoint device;
data transformation accelerator circuitry to perform deserialization of a subset of the data;
parser hardware to:
parse data received at the first port from the network to determine characteristics of the data, wherein the data comprises a data structure serialized according to a serialization format; and
determine that the data transformation hardware is capable of deserializing the serialized data based on the characteristics;
wherein the data transformation hardware deserializes the data structure to generate deserialized data, and the network interface device sends the deserialized data to the endpoint device.

2. The apparatus of claim 1, wherein the serialization format comprises a protocol buffer (protobuf).

3. The apparatus of claim 2, wherein the data is received based on a Remote Procedure Call (RPC) or a Google Remote Procedure Call (gRPC) protocol.

4. The apparatus of claim 1, wherein second data is received from the network at the first port and the parser hardware is to:
parse second data in the received second data to determine characteristics of the second data, wherein the second data comprises other serialized data according to the serialization format; and
determine that the data transformation hardware does not support deserialization of the other serialization data based on the characteristics, wherein the network interface device sends the other serialized data to the endpoint device to be deserialized at the endpoint device prior to consumption of the other serialized data by the endpoint device.

5. The apparatus of claim 1, wherein the endpoint device implements at least a portion of a first program, the data is received from a second program implemented on another system on the network.

6. The apparatus of claim 5, wherein response data is received at the network interface device at the second port from the endpoint device based on the deserialized data, wherein the response data is serialized by the data transformation hardware to generate serialized response data, and the network interface device sends the serialized response data to the other system over the network.

7. The apparatus of claim 5, wherein the first program and the second program are written in different programming languages.

8. The apparatus of claim 1, wherein the network interface processor further comprises protocol selector circuitry to select a particular one of a plurality of sub-protocols of an interconnect protocol to use to send the deserialized data to the endpoint device based on one or more of the characteristics of the packet or characteristics of the endpoint device.

9. The apparatus of claim 8, wherein the interconnect protocol comprises a Compute Express Link (CXL)-based protocol, and the plurality of sub-protocols comprise CXL.io, CXL.mem, and CXL.cache.

10. The apparatus of claim 8, wherein the characteristics of the packet comprise a size of the packet or a quality of service associated with the packet, and the characteristics of the endpoint device comprise a type of the endpoint device or sub-protocols supported by the endpoint device.

11. The apparatus of claim 1, wherein the parser hardware is further to disaggregate data traffic fields from control fields in the packet, and the data traffic fields comprise the serialized data to be deserialized by the data transformation hardware.

12. A method comprising:
receiving a packet from another computing system over a network at a network interface device, wherein the packet is destined for an endpoint computing device coupled to the network interface device;
parsing the packet to detect serialized data within the packet;
determining characteristics of the serialized data;
determining whether deserialization hardware on the network interface device is capable of deserializing the serialized data based on the characteristics;
deserializing the serialized data using the deserialization hardware to generate deserialized data based on determining that the deserialization hardware on the network interface device is capable of deserializing the serialized data;
determining a particular one of a plurality of sub-protocols of a multiprotocol interconnect to use to send the deserialization data; and
sending the deserialized data from the network interface device to the endpoint device over the multiprotocol interconnect using the particular sub-protocol.

13. The method of claim 12, wherein the deserialization hardware is limited to deserializing serialized data meeting a particular set of conditions, and the network interface device is to send serialized data to the endpoint device for deserialization at the endpoint device when the deserialization hardware is incapable of deserializing the serialized data.

14. The method of claim 12, wherein the multiprotocol interconnect is compliant with a CXL-based protocol, and the plurality of sub-protocols comprise CXL.io, CXL.mem, and CXL.cache.

15. A system comprising:
a first computing cluster comprising:
a set of endpoint devices; and
a network interface device comprising:
a processor;
a first port to couple to a network, wherein data is received from the network at the first port, wherein the data comprises serialized data and is destined for a particular one of the set of endpoint devices;
one or more second ports to couple to the set of endpoint devices;
deserialization/serialization acceleration circuitry to perform deserialization of the serialized data;
parser hardware to:
parse the serialized data to determine characteristics of the serialized data; and
determine that the deserialization/serialization acceleration circuitry is capable of deserializing the serialized data based on the characteristics;
wherein the deserialization/serialization acceleration circuitry deserializes the serialized data to generate deserialized data, and the network interface device sends the deserialized data to the particular endpoint device over a multiprotocol link.

16. The system of claim 15, wherein the network interface device comprises one of an infrastructure processing unit (IPU) or a smart network interface card (smart NIC).

17. The system of claim 15, wherein the serialized data comprises protobuf data.

18. The system of claim 15, wherein the set of endpoint devices comprise one or more of a processor device, an accelerator device, or a memory buffer device.

19. The system of claim 15, wherein each endpoint device in the set of endpoint devices comprises deserialization/serialization logic to deserialization serialized data which cannot be deserialized using the deserialization/serialization acceleration circuitry of the network interface device.

20. The system of claim 15, wherein the a network interface device is further to:
determine a particular one of a plurality of sub-protocols of a multiprotocol interconnect to use to send the deserialization data; and
send the deserialized data from the network interface device to the endpoint device over the multiprotocol interconnect using the particular sub-protocol.
